(19) United States
(12) Patent Application Publication
(10) Pub. No.: US 2026/0208736 A1
(43) Pub. Date: Jul. 23, 2026

(54) SCENARIO-BASED ENGAGEMENT OF A MODEL PREDICTIVE CONTROLLER FOR CONTROLLING A VEHICLE

(71) Applicant: GM GLOBAL TECHNOLOGY OPERATIONS LLC, DETROIT, MI (US)

(72) Inventors: Puneet Bagga, Etobicoke (CA); Ben MacCallum, Toronto (CA); Reza Zarringhalam, Whitby (CA); Zhi Li, Unionville (CA); Jimmy Lu, Stouffville (CA)

(21) Appl. No.: 19/026,899

(22) Filed: Jan. 17, 2025

(51) Int. Cl. B60W 30/18; B60W 10/18; B60W 10/20; B60W 30/09; B60W 50/00; B60W 50/02; B60W 50/06; B60W 50/14

(52) U.S. Cl. CPC B60W 30/18163; B60W 10/18; B60W 10/20; B60W 30/09; B60W 50/0097; B60W 50/0205; B60W 50/06; B60W 50/14; B60W 2050/146; B60W 2520/125; B60W 2520/14; B60W 2540/18

(57) ABSTRACT

Examples described herein provide a method that includes receiving metrics for points along a planned path of a vehicle. The method further includes determining whether the metrics satisfy constraints for the metrics. The method further includes, responsive to determining that the metrics do not satisfy the constraints for the metrics, performing a weight optimization. The method further includes, responsive to the metrics satisfying the constraints for the metrics, engaging a model predictive controller to control the vehicle.

### BACKGROUND

The subject disclosure relates to vehicles, and in particular to scenario-based engagement of a model predictive controller for controlling a vehicle.

Modern vehicles (e.g., a car, a motorcycle, a boat, or any other type of automobile) may be equipped with one or more cameras that provide back-up assistance, take images of the vehicle driver to determine driver drowsiness or attentiveness, provide images of the road as the vehicle is traveling for collision avoidance purposes, provide structure recognition (e.g., roadway signs, etc.), and/or the like, including combinations and/or multiples thereof. For example, a vehicle can be equipped with multiple cameras, and images from multiple cameras (referred to as “surround view cameras”) can be used to create a “surround” or “bird's eye” view of the vehicle. Some of the cameras (referred to as “long-range cameras”) can be used to capture long-range images (e.g., for object detection for collision avoidance, structure recognition, etc.).

Such vehicles can also be equipped with sensors such as a radar device(s), lidar device(s), and/or the like for perception tasks. Radar (radio detection and ranging) is a technology that uses radio waves to detect and determine the distance, speed, and angle of objects. Radar works by emitting radio signals that bounce off objects and return to the radar system, where the reflected waves are analyzed based on the amount of time between emission and reception. The measured time can be used to determine the distance between the radar device and the detected object, which can be used when performing perception tasks.

Perception tasks can include one or more of object detection, classification, tracking, lane detection, road sign recognition, and obstacle avoidance. Perception tasks are particularly useful for an autonomous or semi-autonomous vehicle to provide the vehicle with real-time awareness of its environment to make safe and informed driving decisions. Images from the one or more cameras of the vehicle can also be used for detecting objects, tracking targets, and/or the like, including combinations and/or multiples thereof. Perception tasks are useful for implementing advanced driver assistance systems (ADASs).

The desire for precise vehicle control using ADASs is important for efficient operation of the vehicle.

### SUMMARY

In one embodiment, a computer-implemented method is provided. The method includes receiving metrics for points along a planned path of a vehicle. The method further includes determining whether the metrics satisfy constraints for the metrics. The method further includes, responsive to determining that the metrics do not satisfy the constraints for the metrics, performing a weight optimization. The method further includes, responsive to the metrics satisfying the constraints for the metrics, engaging a model predictive controller to control the vehicle.

In addition to one or more of the features described herein, or as an alternative, further embodiments of the method may include that the model predictive controller is disabled while the metrics do not satisfy the constraints for the metrics.

In addition to one or more of the features described herein, or as an alternative, further embodiments of the method may include that the metrics are selected from a group consisting of a lateral error, a heading error, a lateral velocity, a yaw rate, a lateral acceleration, a steering angle, and a steering rate.

In addition to one or more of the features described herein, or as an alternative, further embodiments of the method may include that the metrics include a lateral error, a heading error, a lateral velocity, a yaw rate, a lateral acceleration, a steering angle, and a steering rate.

In addition to one or more of the features described herein, or as an alternative, further embodiments of the method may include that the weight optimization is performed iteratively until the metrics satisfy the constraints for the metrics.

In addition to one or more of the features described herein, or as an alternative, further embodiments of the method may include displaying an indicium to a driver of the vehicle to prompt the driver to control the vehicle to cause an active safety feature to engage.

In addition to one or more of the features described herein, or as an alternative, further embodiments of the method may include that model predictive controller controls the vehicle by engaging an active safety feature.

In addition to one or more of the features described herein, or as an alternative, further embodiments of the method may include that the active safety feature is selected from a group consisting of active cruise control, automated lane change, front collision alert, collision imminent breaking, and automated evasive steering.

In another embodiment, a vehicle is provided. The vehicle includes a processing system having a memory with computer readable instructions and a processing device for executing the computer readable instructions. The computer readable instructions control the processing system to perform operations. The operations include receiving metrics for points along a planned path of the vehicle. The operations further include determining whether the metrics satisfy constraints for the metrics. The operations further include, responsive to determining that the metrics do not satisfy the constraints for the metrics, performing a weight optimization to optimize model predictive control weights for the vehicle. The operations further include, subsequent to performing the weight optimization to optimize model predictive control weights for the vehicle, determining whether the metrics satisfy the constraints for the metrics. The operations further include, responsive to the metrics satisfying the constraints for the metrics subsequent to performing the weight optimization to optimize model predictive control weights for the vehicle, engaging a model predictive controller to control the vehicle.

In addition to one or more of the features described herein, or as an alternative, further embodiments of the vehicle may include that the model predictive controller is disabled while the metrics do not satisfy the constraints for the metrics.

In addition to one or more of the features described herein, or as an alternative, further embodiments of the vehicle may include that the metrics are selected from a group consisting of a lateral error, a heading error, a lateral velocity, a yaw rate, a lateral acceleration, a steering angle, and a steering rate.

In addition to one or more of the features described herein, or as an alternative, further embodiments of the vehicle may include that the metrics include a lateral error, a heading error, a lateral velocity, a yaw rate, a lateral acceleration, a steering angle, and a steering rate.

In addition to one or more of the features described herein, or as an alternative, further embodiments of the vehicle may include that the weight optimization is performed iteratively until the metrics satisfy the constraints for the metrics.

In addition to one or more of the features described herein, or as an alternative, further embodiments of the vehicle may include that the operations further include displaying an indicium to a driver of the vehicle to prompt the driver to control the vehicle to cause an active safety feature to engage.

In addition to one or more of the features described herein, or as an alternative, further embodiments of the vehicle may include that the model predictive controller controls the vehicle by engaging an active safety feature.

In addition to one or more of the features described herein, or as an alternative, further embodiments of the vehicle may include that the active safety feature is selected from a group including active cruise control, automated lane change, front collision alert, collision imminent breaking, and automated evasive steering.

In another embodiment a computer program product is provided. The computer program product includes a set of one or more computer-readable storage media and program instructions, collectively stored in the set of one or more storage media, for causing a processor set to perform computer operations. The operations include receiving metrics for points along a planned path of a vehicle, wherein the metrics include a lateral error, a heading error, a lateral velocity, a yaw rate, a lateral acceleration, a steering angle, and a steering rate. The operations further include determining whether the metrics satisfy constraints for the metrics. The operations further include, responsive to determining that the metrics do not satisfy the constraints for the metrics, performing a weight optimization. The operations further include, responsive to the metrics satisfying the constraints for the metrics, engaging a model predictive controller to control the vehicle.

In addition to one or more of the features described herein, or as an alternative, further embodiments of the computer program product may include that the model predictive controller is disabled while the metrics do not satisfy the constraints for the metrics.

In addition to one or more of the features described herein, or as an alternative, further embodiments of the computer program product may include that the weight optimization is performed iteratively until the metrics satisfy the constraints for the metrics.

In addition to one or more of the features described herein, or as an alternative, further embodiments of the computer program product may include that the model predictive controller controls the vehicle by engaging an active safety feature, and wherein the active safety feature is selected from a group consisting of active cruise control, automated lane change, front collision alert, collision imminent breaking, and automated evasive steering.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates a vehicle with a processing system and a sensor according to one or more embodiments;

FIG. 2 illustrates the processing system of FIG. 1 according to one or more embodiments;

FIG. 3A illustrates a block diagram of a system for scenario-based engagement of a model predictive controller for controlling a vehicle according to one or more embodiments;

FIG. 3B illustrates a block diagram of a system for optimizing weights and evaluating predicted motion for scenario-based engagement of a model predictive controller for controlling a vehicle according to one or more embodiments;

FIG. 4 illustrates a diagram of historic performance tracker before engagement of a model predictive controller according to one or more embodiments;

FIG. 5 depicts a flow diagram of a method for scenario-based engagement of a model predictive controller for controlling a vehicle according to one or more embodiments; and

FIG. 6 illustrates a block diagram of a processing system for scenario-based engagement of a model predictive controller for controlling a vehicle according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein, the term “controller” (e.g., a charging controller as further described herein) refers to a dedicated controller including a processor and a memory, a general controller including control modules configured to enact a control process using the dedicated controller, a network of multiple distinct controllers in communication with each other and each including processors and memory and being configured to cooperatively implement the control process, and any similar configuration for implementing the control process.

One or more embodiments described herein relates to scenario-based engagement of a model predictive controller for controlling a vehicle.

Vehicles may use advanced driver assistance systems (ADASs) to improve vehicle performance and enhance driving comfort by providing automating, adapting, or enhancing vehicle systems to provide better awareness, decision-making, and control.

One example of an ADAS is an adaptive cruise control (ACC) system, which automatically adjusts the velocity of a vehicle to maintain a safe following distance from another vehicle ahead of the vehicle. Another example of an ADAS is an automated lane change (ALC) system to cause the vehicle to perform a lane change. Another example of an ADAS is a front collision alert (FCA) system to generate an alert to an operator of the vehicle warning of a potential front collision. Another example of an ADAS is a collision imminent braking (CIB) system to apply brakes of the vehicle to reduce a velocity of the vehicle. Another example of an ADS is an automated evasive steering (AES) system to adjust the trajectory of the vehicle.

ADASs often use data (referred to as “sensor data”) from sensors (e.g., radar sensors, lidar sensors, proximity sensors, etc.), images from cameras, and/or the like, including combinations and/or multiples thereof, to perform perception tasks, make decisions, and control one or more aspects of the vehicle. Modern vehicle systems rely on advanced technologies to perform perception tasks, such as detecting, classifying, and tracking objects. These capabilities are useful for systems that enable accurate and efficient navigation, including semi-autonomous or autonomous operation of a vehicle, by understanding, in real-time, an environment of the vehicle.

ADASs, which may also be referred to as “active safety features,” can be engaged or disengaged automatically or manually. In some cases, the enablement of an ADASs engaged when certain operating conditions are satisfied. That is, ADASs may be prevented from being engaged in certain situations. For example, where a heading and lateral offset of the vehicle differs from a target heading and lateral offset by a threshold amount, ADASs may be prevented from being engaged.

The desire for precise vehicle control using ADASs is important for efficient operation of the vehicle, and as such, it is desirable to provide for engaging ADASs in certain scenarios while preventing such engagement in other scenarios.

One or more embodiments provide for scenario-based engagement of a model predictive controller for controlling a vehicle. A model predictive controller (MPC) is an advanced control system or controller that is used to make real-time decisions on vehicle control, such as steering, acceleration, and braking.

One or more embodiments described herein provide for evaluating an MPC's predicted motion and adjusting parameters to allow engagement of an active safety feature (e.g., an ADAS) by evaluating commands through an engagement supervisor that compares given commands with vehicle constraints. Given how satisfactory the commands are, the engagement supervisor can adjust or readjust MPC weights to improve efficiency.

One or more embodiments described herein provide for optimizing and evaluating MPC weights in real time to engage active safety features in different driving scenarios. MPC weights can be optimized based on which parameters are prioritized by the engagement supervisor. MPC weights are ramped in from defaults then ramped out back to optimal driving weights.

One or more embodiments described herein provide a steer-to-engage mechanism that enables a driver of the vehicle to adjust vehicle position and heading engage an active safety feature (e.g., an ADAS). For example, the driver is provided a first indicium indicating a direction to move a steering wheel (e.g., via a human machine interface (HMI)), and once the position is reach, a second indicium (e.g., a flashing light bar) can indicate engagement (e.g., the flashing light bar becomes a solid light bar). Various indicium, including visual, audible, and/or tactile alerts can be used in embodiments.

One or more embodiments described herein provide an approach to deciding whether to adapt or engage the MPC based on historic engagement of active safety features. For example, success of past engagement of an active safety feature is recorded, and using this information, the engagement supervisor can decide to readjust MPC weights, alert a driver to adjust vehicle position, refuse engagement of the active safety feature, and/or the like, including combinations and/or multiples thereof.

One or more embodiments described herein provide a model predictive control design with optimal engagement at the onset of a maneuver and interactions with feature moding. “Feature moding” refers to determine whether to enable an active safety feature. That is, feature moding selectively enables an active safety feature or disables an active safety feature, depending, for example, on a received flag or indication (e.g., “safe to engage flag”). A controller design is provided that is adaptable to new MPC weights and constraints and, with interactions from feature moding, can transition between active safety feature engagement smoothly in different scenarios.

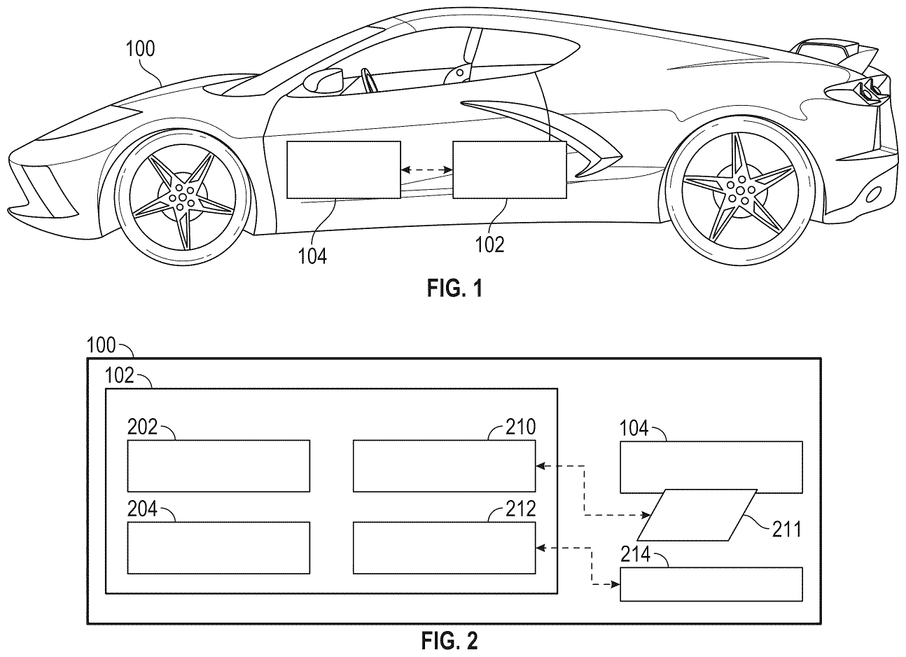

FIG. 1 shows a vehicle 100 with a processing system 102 and sensor 104 according to one or more embodiments. The vehicle 100 can be a car, a truck, a van, a bus, a motorcycle, a boat, or any other type of automobile. According to an embodiment, the vehicle 100 is a hybrid electric vehicle, such as a plug-in hybrid electric vehicle (PHEV) partially or wholly powered by electrical power. According to another embodiment, the vehicle 100 is an electric vehicle powered by electrical power. A battery (not shown) is used to provide electrical power to components of the vehicle 100, such as an electric motor (not shown), electrical components (not shown), and/or the like, including combinations and/or multiples thereof. According to one or more embodiments, the vehicle 100 includes an internal combustion engine (not shown) that provides electrical and/or mechanical energy for providing propulsion to the vehicle 100. According to one or more embodiments, the vehicle 100 is an autonomous or semi-autonomous vehicle. An autonomous vehicle is a vehicle that has self-driving capabilities. A semi-autonomous vehicle is a vehicle that has certain autonomous features (e.g., self-parking, lane keeping, etc.) but lacks full autonomous control.

The processing system 102 is located within the vehicle and is responsible for managing and processing data collected by the sensor 104. The sensor 104 represents one or more sensors, which may vary in type. The sensor 104 may be any suitable sensor(s) and/or combination of sensors, such as a camera, a radar device, a lidar device, a proximity sensor, and/or the like, including combinations and/or multiples thereof. The arrows between the sensor 104 and the processing system 102 indicate the flow of data from the sensor 104 to the processing system 102, highlighting the interaction between these components. This setup enables the vehicle 100 to perform tasks perception tasks, which can be used for autonomous driving for example, using the data collected by the sensor 104. According to one or more embodiments, the processing system 102 can be used to selectively engage an active safety feature (e.g., an ADAS) as further described herein.

Further features of the processing system 102 and the sensor 104 are now described with reference to FIG. 2.

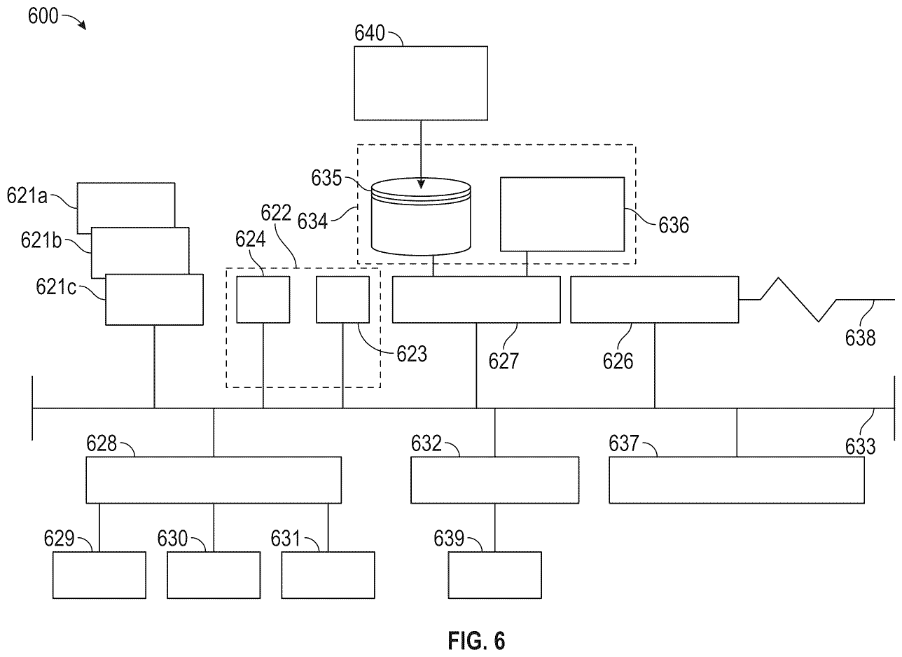

Particularly, FIG. 2 illustrates the processing system of FIG. 1 according to one or more embodiments. According to one or more embodiments, the processing system 102 includes a processing device 202, a memory 204, an engagement supervisor engine 210, and an MPC engine 212, which is an example of a model predictive controller. It should be appreciated that the processing system 102 can be any device suitable for engagement of a model predictive controller (e.g., the MPC engine 212) for controlling a vehicle. For example, the processing system 102 can be a device implemented in or otherwise associated with the vehicle 100, such as an electronic control unit (also referred to as an electronic control module). As another example, the processing system 102 can be a smartphone, tablet computer, laptop computer, desktop computer, wearable computing device, and/or the like, including combinations and/or multiples thereof. As yet another example, the processing system 102 can be the processing system 600 of FIG. 6 and/or can include one or more components of the processing system 600 of FIG. 6.

The processing device 202 is responsible for executing instructions and managing the overall operation of the processing system 102. The processing device 202 can be any suitable processing circuitry for executing instructions and processing data. For example, the processing device 202 can be a microcontroller, microprocessor, application-specific integrated circuit (ASIC), or any other type of processing unit capable of handling the computational demands of the processing system 102. The processing device 202 is an example of one or more of the processing devices 621 of FIG. 6, as described in more detail herein.

The memory 204 stores data (e.g., data 211), computer-readable instructions, and algorithms useful for operation of the processing system 102. This may include real-time data processing, historical data analysis, and storage of firmware or software programs. The memory 204 is any suitable device for storing data, such as the data 211, and/or instructions. For example, the memory 204 can be a combination of volatile memory (e.g., random access memory) and non-volatile memory (e.g., read-only memory, flash memory). The memory 204 is an example of one or more of the system memory 622, the random access memory 623, and/or the read-only memory 624 of FIG. 6, as described in more detail herein.

The processing system 102 receives data 211 (from the sensor 104) about the vehicle 100 (e.g., telemetry data about the vehicle) and/or about the environment in which the vehicle is operating (e.g., images of objects in the environment, point cloud data of objects in the environment, etc.). According to one or more embodiments, the data 211 can be images of a lane in which the vehicle 100 is traveling, including any lane markers (e.g., lane lines, turn indicators, etc.) of the lane. The data 211 can be useful, for example, for performing perception tasks, which in turn are used to control the vehicle using an ADAS.

The engagement supervisor engine 210 is responsible for determining whether it is acceptable to engage the MPC engine 212. According to one or more embodiments, the engagement supervisor engine 210 does not engage the MPC engine 212 but rather indicates that it is acceptable for the MPC engine 212 to be engaged. Once engaged, the MPC engine 212 acts as the underlying control strategy for implementing ADAS (e.g., active safety features). More particularly, the MPC engine 212 predicts points on a future path of the vehicle, which are fed back into the engagement supervisor engine 210. The MPC engine 212, once engaged, also interacts with a vehicle plant 214 that controls electromechanical components of the vehicle, such as actuators, that in turn control aspects of the vehicle, such as steering, braking, acceleration, and/or the like, including combinations and/or multiples thereof. Together, the engagement supervisor engine 210 and the MPC engine 212 using predictions to make more informed decisions about engaging active safety feature, which can increase the opportunities for engagement of active safety feature by adapting the MPC engine 212 based on predictions.

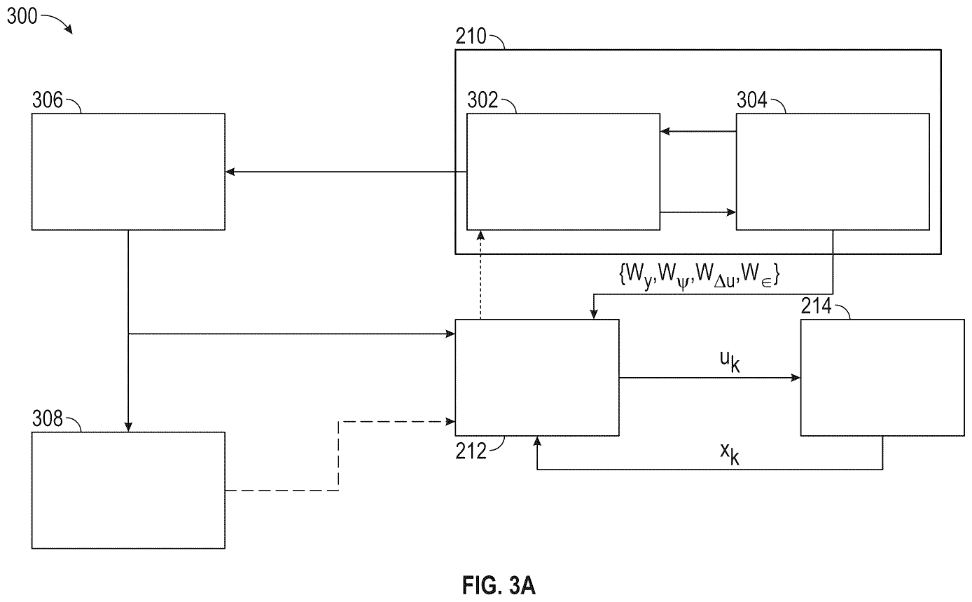

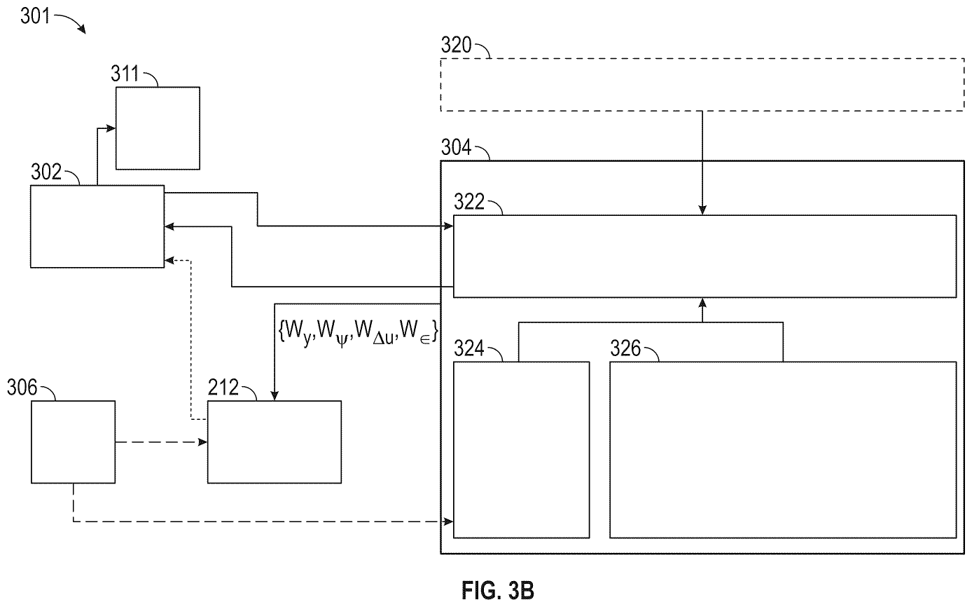

Features and functions of the engagement supervisor engine 210 and the MPC engine 212 are further described with respect to FIGS. 3-5.

FIG. 3A illustrates a block diagram of a system 300 for scenario-based engagement of a model predictive controller for controlling a vehicle according to one or more embodiments. The system includes several components that interact to enable the engagement of active safety features for the vehicle 100 based on predictions and real-time adjustments.

The engagement supervisor engine 210 receives predictions from the MPC engine 212 and evaluates them against a set of constraints at block 302. In particular, block 302 provides for evaluating predicted motion of the vehicle 100. If the predictions satisfy the constraints, the engagement supervisor engine at block 302 indicates to block 306 (feature moding) that it is safe to engage the MPC engine 212 to enable one or more active safety features (e.g., one or more ADASs). If not, the engagement supervisor engine performs weight optimization at block 304 to adjust MPC weights and improve the predictions of the MPC engine 212. The MPC weights are optimized iteratively to satisfy engagement conditions for engaging the one or more active safety features (e.g., one or more ADASs). The MPC weights are fed to the MPC engine 212 as shown. Examples of MPC weights include but are not limited to: weight of lateral deviation from target path (Wy), weight of heading deviation from target path (Wy), weight of steering angle (WAu), and weight of lateral acceleration (We). The iterative process for MPC weight optimization at block 304 of the engagement supervisor engine 210 continues until the predictions satisfy the constraints or a timeout occurs, indicating that engagement is not possible under the current conditions.

At block 306, feature moding is performed, which includes determining whether to engage an active safety feature. It evaluates various conditions and sends an enablement flag to a planner 308 and to the MPC engine 212 if the conditions are met.

Once the feature moding component enables the active safety feature, the planner 308 provides a planned path for the vehicle 100 to follow. This planned path could be the center of the lane, a path to avoid an obstacle, etc. The planned path is transmitted to the MPC engine 212.

The MPC engine 212 attempts to realize the planned path by engaging the vehicle plant 214, which may include steering actuator or other vehicle actuators, to control the vehicle to follow the planned path from the planner 308. The MPC engine 212 uses model predictive control to generate predictions (Ipred) of the vehicle's future states.

FIG. 3B illustrates a block diagram of a system 301 for optimizing weights and evaluating predicted motion for scenario-based engagement of a model predictive controller for controlling a vehicle according to one or more embodiments. The diagram highlights the interaction between various components involved in the process of engaging the MPC engine 212 to enable one or more active safety features based on real-time predictions and weight optimization.

Block 304 is used to optimize the MPC weights and includes a weight optimizer 322. Vehicle states, such as lateral position, lateral velocity, yaw angle, steering rate, steering angle, lateral acceleration, road geometry, and/or the like, including combinations and/or multiples thereof, are received from block 320 by block 304. If the predicted motion does not satisfy the constraints, the weight optimizer adjusts the MPC weights to improve the performance. The optimization process continues iteratively until the predictions meet the constraints or a timeout occurs. The weight optimizer 322 utilizes planner objectives 324 and model predictive constraints 326. The planner objectives 324 include, for example, lateral offset from target based on the planned path, heading error from target based on the planned path, and/or the like, including combinations and/or multiples thereof. The model predictive constraints 326 include various constraints, such as maximum lateral velocity (V_{y}), maximum \ddot{ψ}, maximum steering rate, maximum lateral acceleration (A_{y}), maximum lateral offset, maximum heading error, maximum lateral jerk, maximum steering angle, and/or the like, including combinations and/or multiples thereof.

The MPC weights are sent to the MPC engine 212, which generates predictions (x̅_{pred}) of the vehicle's future states. These predictions are sent to block 302, where predicted motion evaluation is performed. That is, block 304 evaluates the predicted motion of the vehicle 100 based on the current state (from block 320) and planned path from the planner 308 and assesses whether these predictions meet predefined conditions. If so, the active safety feature can be enabled at block 311. If not, weight optimization can be iteratively performed.

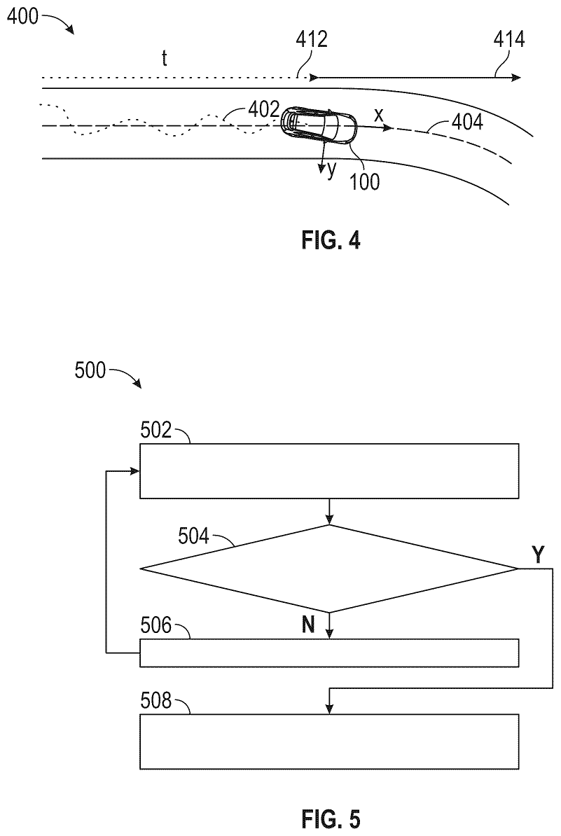

FIG. 4 illustrates a diagram 400 of historic performance tracker before engagement of a model predictive controller according to one or more embodiments. Particularly, the diagram 400 depicts an approach to deciding whether to adapt or engage the MPC engine 212 based on historic engagement of active safety features. For example, success of past engagement of an active safety feature is recorded, and using this information, the engagement supervisor can decide to readjust MPC weights, alert a driver to adjust vehicle position, refuse engagement of the active safety feature, and/or the like, including combinations and/or multiples thereof.

The vehicle trajectory 402 represents the trajectory of the vehicle 100 that is measured or observed over a period of time defined as monitoring window t 412. This is the time window during which the vehicle's performance is being monitored. It extends from the current time to a point in the past (e.g., the last 30 seconds), allowing for the evaluation of the vehicle's actual trajectory (vehicle trajectory 402) against the planned trajectory (reference trajectory 404). Points in time projected ahead of the vehicle are point in the future 414.

In this embodiment, the processing system 102 can utilize an MPC performance tracker (not shown) which may be part of the MPC engine 212 or a separate component. The MPC performance tracker (e.g., the MPC engine 212) can adapt MPC control parameters based on historic information to decide whether to engage MPC. This can be useful in various vehicle operating scenarios, such as entering a curve (curve entry case), exiting a curve (curve exit case), or straight path operation (straight path case). FIG. 4 shows an example of the curve entry case where the vehicle 100 is entering a curve.

The MPC performance tracker can determine whether the vehicle is struggling with complex scenarios (e.g., curve entry case, curve exit case, straight path case) by monitoring weight inputs/outputs to determine whether the vehicle is tracking the reference trajectory 404. For example, the MPC performance tracker can evaluate oscillation frequency of the vehicle trajectory 402 as compared to the reference trajectory 404, the maximum deviation between the vehicle trajectory 402 and the reference trajectory 404, and/or the like, including combinations and/or multiples thereof. The MPC performance tracker can also evaluate hard constraints, such as: mechanical constraints on the steering angle and angle rate; safe limits on lateral acceleration, yaw rate, and velocity; upper bounds on lateral error and heading error to prevent unreasonable overshoot from the target path that could result in a collision or road excursion; and/or the like, including combinations and/or multiples thereof, and the number of times these hard constraints were reached.

The following table depicts historic performance tracker factors, the evaluation criteria for when fulfilled, and a number of occurrences.

| Historic Performance | Criteria | Number of |
|---|---|---|
| Tracker Factors | Fulfilled | Occurrence |
| Max lateral deviation | <l_{Max}_{_{Straight}}, l_{Max}_{_{Curve}} | N_{LP}_{_{Max}} |
| and average lane | <l_{AvgMax}_{_{Straight}}, l_{Avg}_{_{Curve}} | N_{LP}_{_{Avg}} |
| position in straight and | | |
| curve roads | | |
| Allowable lateral | <A_{y}_{_{Straight}}, A_{y}_{_{Curve}} | N_{LA} |
| acceleration in straight | | |
| and curve roads | | |
| Hand wheel stability | <\dot{φ}_{Max}_{_{Straight}}, \dot{φ}_{Max}_{_{Curve}} | N_{HW} |
| Vehicle oscillations | <l_{Max}_{_{Straight}}_{\|Freq}, l_{Max}_{_{Curve}}_{\|Freq} | N_{OS} |

With reference to variables in the table, l_{Max}_{_{straight}}, l_{Max}_{_{Curve}} represent maximum lateral deviation in lane position in straight roads and curve, respectively; l_{AvgMax}_{_{Straight}}, l_{Avg}_{_{Curve}} represent average lateral deviation in lane position in straight roads and curve, respectively; N_{LP}_{_{Max}} represent a number of discrete violations of lateral deviation limit in historical window: N_{LP}_{_{Avg}} represents a number of discrete violations of average lateral error limit in historical window; A_{y}_{_{Straight}}, A_{y}_{_{Curve}} represent lateral acceleration limit for straight road and curve, respectively; NLA represents a number of discrete violations of lateral acceleration limit in historical window; \dot{φ}_{Max}_{_{Straight}}, \dot{Φ}_{Max}_{_{Curve}} represent hand wheel angle rate limit for straight road and curve, respectively; N_{HW} represents a number of discrete violations of hand wheel angle rate limit in historical window; l_{Max}_{_{Straight}}_{|Freq}, l_{Max}_{_{Curve}}_{|Freq} represent magnitude of lateral position oscillations for straight road and curved road, respectively; and N_{OS} represents a number of discrete violations of lateral position oscillation limit in historical window.

FIG. 5 illustrates a flow diagram of a method 500 for camera-based estimation of vehicle center of gravity for model-based vehicle control according to one or more embodiments. The method 500 can be implemented using any suitable system or device. For example, the method 500, and its steps, can be implemented using the processing system 102 of FIGS. 1 and 2, by the processing system 600 of FIG. 6, and/or the like, including combinations and/or multiples thereof. The method 500 is now described with reference to at least portions of FIGS. 1-4 but is not so limited.

At block 502, the method 500 begins with the engagement supervisor engine 210 receiving metrics for various points along the planned path of the vehicle 100. These metrics can include parameters, such as lateral error, heading error, lateral velocity, yaw rate, lateral acceleration, steering angle, and steering rate, among others.

At decision block 504, the engagement supervisor engine 210 determines whether the received metrics satisfy predefined conditions or constraints. This decision point evaluates if the metrics are within acceptable limits for safe engagement of the MPC engine 212. If not, (decision block 504, “N”), the method 500 proceeds to block 506, where weight optimization is performed. If so, (decision block 504, “Y”), the method 500 proceeds to block 508, where the MPC engine 212 is engaged.

More particularly, at block 506, the engagement supervisor engine 210 performs weight optimization. This step involves adjusting the MPC weights to improve the performance and ensure that the metrics can meet the required conditions. According to one or more embodiments, the weight optimization is performed iteratively until the metrics satisfy the constraints.

Once the metrics satisfy the conditions, the method 500 proceeds to block 508 where the engagement supervisor engine 210 engages the MPC engine 212 to control the vehicle 100. This step involves activating the active safety feature to manage aspects of the vehicle's motion, such as steering, braking, and acceleration, based on the optimized metrics and planned path.

According to one or more embodiments, controlling the vehicle 100 can include the MPC engine 212 controlling the vehicle by engaging an active safety feature, such as active cruise control, automated lane change, front collision alert, collision imminent breaking, automated evasive steering, lane centering control, lane keep assist, lane centering assist, and/or the like, including combinations and/or multiples thereof.

According to one or more embodiments, the method 500 can include displaying an indicium to a driver of the vehicle to prompt the driver to control the vehicle to cause an active safety feature to engage. For example, an arrow on a HMI (e.g., a heads up display) can point in a direction, where the active safety feature would engage if the driver steers the vehicle in that direction.

Additional processes also may be included, and it should be understood that the processes depicted in FIG. 5 represent illustrations, and that other processes may be added, or existing processes may be removed, modified, or rearranged without departing from the scope of the present disclosure. It should also be understood that the processes depicted in FIG. 5 may be implemented as programmatic instructions stored on a non-transitory computer-readable storage medium that, when executed by a processor (e.g., the processing device 202 of FIG. 2, the processor(s) 621 of FIG. 6, and/or the like, including combinations and/or multiples thereof) of a computing system (e.g., the processing system 102 of FIGS. 1 and 2, the processing system 600 of FIG. 6, and/or the like, including combinations and/or multiples thereof), cause the processor to perform the processes described herein.

One or more embodiments offer significant technical benefits. For example, one or more embodiments described herein improve the operation of the vehicle 100 by enhancing the engagement and control of active safety features through a scenario-based engagement of a model predictive controller (e.g., MPC engine 212). Some of the improvements provided by one or more embodiments described herein are as follows, although other improvements are possible.

One or more embodiments provide enhanced decision-making for feature engagement. For example, the engagement supervisor engine 210 evaluates the predicted motion of the vehicle 100 against a set of constraints. By using real-time predictions, one or more embodiments can make more informed decisions about whether it is safe to engage active safety features. This increases the opportunities for engagement by adapting the MPC based on predictions, leading to efficient and more reliable activation of features, such as lane keep assist, lane centering control, and assisted evasive steering.

One or more embodiments provide real-time weight optimization. For example, one or more embodiments includes a weight optimization routine that adjusts the MPC weights iteratively until the predicted motion satisfies the predefined constraints. This real-time optimization ensures that the vehicle's control parameters are continuously fine-tuned for optimal performance, improving the vehicle's ability to follow the planned path accurately and safely.

One or more embodiments provide a steer-to-engage mechanism. For example, one or more embodiments provide a steer-to-engage mechanism that enables the driver to adjust the vehicle's position and heading to engage an active safety feature. The driver receives visual, audible, or tactile feedback indicating the direction to move the steering wheel. Once the desired position is reached, the system indicates engagement. This mechanism allows for smoother and more efficient transitions to automated control, enhancing the overall driving experience.

One or more embodiments provide historic performance tracking. For example, one or more embodiments records the success of past engagements of active safety features and uses this information to make future decisions. By analyzing historic data, the engagement supervisor can decide to readjust MPC weights, alert the driver to adjust the vehicle's position, or refuse engagement if desired. This adaptive approach ensures that the vehicle 100 learns from past experiences, leading to continuous improvement in vehicle control.

One or more embodiments provide improved comfort and safety. For example, one or more embodiments evaluates various metrics, such as lateral error, heading error, lateral velocity, yaw rate, lateral acceleration, steering angle, and steering rate. By ensuring that these metrics are within acceptable limits, one or more embodiments enhances vehicle functionality. For example, constraints on lateral acceleration and yaw rate help maintain a smooth and comfortable ride, while accurate steering control ensures the vehicle stays within its lane.

One or more embodiments provide increased engagement scenarios. For example, by using predictive models and real-time adjustments, one or more embodiments extends the number of scenarios where active safety features can be engaged with confidence. This includes complex driving conditions, such as entering or exiting curves, straight path operation, and scenarios requiring quick evasive maneuvers. The ability to engage features in a wider array of scenarios provides a more satisfactory and safer driving experience for customers.

Overall, one or more embodiments described herein improve the operation of the vehicle 100 by providing a more intelligent, adaptive, and reliable system for engaging and controlling active safety features, leading to enhanced efficiency, comfort, and driving experience.

It is understood that one or more embodiments described herein is capable of being implemented in conjunction with any other type of computing environment now known or later developed. For example, FIG. 6 depicts a block diagram of a processing system 600 for implementing the techniques described herein. In accordance with one or more embodiments described herein, the processing system 600 is an example of a cloud computing node of a cloud computing environment. In examples, processing system 600 has one or more central processing units (referred to also as “processors” or “processing resources” or “processing devices”) 621a, 621b, 621c, etc. (collectively or generically referred to as processor(s) 621 and/or as processing device(s) 621). In aspects of the present disclosure, each processor 621 can include a reduced instruction set computer (RISC) microprocessor. Processors 621 are coupled to a system memory 622 and/or various other components via a system bus 633. The system memory 622 can include one or more temporary and/or persistent memory devices, such as a random access memory (RAM) 623, a read-only memory (ROM) 624, and/or the like, including combinations and/or multiples thereof. The system bus 633 may include a basic input/output system (BIOS), which controls certain basic functions of processing system 600.

Further depicted are an input/output (I/O) adapter 627 and a network adapter 626 coupled to system bus 633. I/O adapter 627 may be a small computer system interface (SCSI) adapter that communicates with a hard disk 635 and/or a storage device 636 or any other similar component. I/O adapter 627, hard disk 635, and storage device 636 are collectively referred to herein as mass storage 634. Operating system 640 for execution on processing system 600 may be stored in mass storage 634. The network adapter 626 interconnects system bus 633 with an outside network 638 enabling processing system 600 to communicate with other such systems.

A display (e.g., a display monitor) 639 is connected to system bus 633 by display adapter 632, which may include a graphics adapter to improve the performance of graphics intensive applications and a video controller. In one aspect of the present disclosure, adapters 626, 627, and/or 632 may be connected to one or more I/O buses that are connected to system bus 633 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 633 via user interface adapter 628 and display adapter 632. A keyboard 629, mouse 630, and speaker 631 may be interconnected to system bus 633 via user interface adapter 628, which may include, for example, a Super I/O chip integrating multiple device adapters into a single integrated circuit.

In some aspects of the present disclosure, processing system 600 includes a graphics processing unit (GPU) 637. Graphics processing unit 637 is a specialized electronic circuit designed to manipulate and alter memory to accelerate the creation of images in a frame buffer intended for output to a display. In general, graphics processing unit 637 is very efficient at manipulating computer graphics and image processing and has a highly parallel structure that makes it more effective than general-purpose CPUs for algorithms where processing of large blocks of data is done in parallel.

Thus, as configured herein, processing system 600 includes processing capability in the form of processors 621, storage capability including the system memory 622 and mass storage 634, input means such as keyboard 625 and mouse 630, and output capability including speaker 631 and display 639. In some aspects of the present disclosure, a portion of system memory 622 and mass storage 634 collectively store the operating system 640 to coordinate the functions of the various components shown in processing system 600.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A computer-implemented method comprising:
receiving metrics for points along a planned path of a vehicle;
determining whether the metrics satisfy constraints for the metrics;
responsive to determining that the metrics do not satisfy the constraints for the metrics, performing a weight optimization; and
responsive to the metrics satisfying the constraints for the metrics, engaging a model predictive controller to control the vehicle.

2. The computer-implemented method of claim 1, wherein the model predictive controller is disabled while the metrics do not satisfy the constraints for the metrics.

3. The computer-implemented method of claim 1, wherein the metrics are selected from a group consisting of a lateral error, a heading error, a lateral velocity, a yaw rate, a lateral acceleration, a steering angle, and a steering rate.

4. The computer-implemented method of claim 1, wherein the metrics comprise a lateral error, a heading error, a lateral velocity, a yaw rate, a lateral acceleration, a steering angle, and a steering rate.

5. The computer-implemented method of claim 1, wherein the weight optimization is performed iteratively until the metrics satisfy the constraints for the metrics.

6. The computer-implemented method of claim 1, further comprising displaying an indicium to a driver of the vehicle to prompt the driver to control the vehicle to cause an active safety feature to engage.

7. The computer-implemented method of claim 1, wherein model predictive controller controls the vehicle by engaging an active safety feature.

8. The computer-implemented method of claim 7, wherein the active safety feature is selected from a group consisting of active cruise control, automated lane change, front collision alert, collision imminent breaking, and automated evasive steering.

9. A vehicle comprising:
a processing system comprising:
a memory comprising computer readable instructions; and
a processing device for executing the computer readable instructions, the computer readable instructions controlling the processing system to perform operations comprising:
receiving metrics for points along a planned path of the vehicle;
determining whether the metrics satisfy constraints for the metrics;
responsive to determining that the metrics do not satisfy the constraints for the metrics, performing a weight optimization to optimize model predictive control weights for the vehicle;
subsequent to performing the weight optimization to optimize model predictive control weights for the vehicle, determining whether the metrics satisfy the constraints for the metrics; and
responsive to the metrics satisfying the constraints for the metrics subsequent to performing the weight optimization to optimize model predictive control weights for the vehicle, engaging a model predictive controller to control the vehicle.

10. The vehicle of claim 9, wherein the model predictive controller is disabled while the metrics do not satisfy the constraints for the metrics.

11. The vehicle of claim 9, wherein the metrics are selected from a group consisting of a lateral error, a heading error, a lateral velocity, a yaw rate, a lateral acceleration, a steering angle, and a steering rate.

12. The vehicle of claim 9, wherein the metrics comprise a lateral error, a heading error, a lateral velocity, a yaw rate, a lateral acceleration, a steering angle, and a steering rate.

13. The vehicle of claim 9, wherein the weight optimization is performed iteratively until the metrics satisfy the constraints for the metrics.

14. The vehicle of claim 9, wherein the operations further comprise displaying an indicium to a driver of the vehicle to prompt the driver to control the vehicle to cause an active safety feature to engage.

15. The vehicle of claim 9, wherein the model predictive controller controls the vehicle by engaging an active safety feature.

16. The vehicle of claim 15, wherein the active safety feature is selected from a group consisting of active cruise control, automated lane change, front collision alert, collision imminent breaking, and automated evasive steering.

17. A computer program product comprising:
a set of one or more computer-readable storage media;
program instructions, collectively stored in the set of one or more storage media, for causing a processor set to perform computer operations comprising:
receiving metrics for points along a planned path of a vehicle, wherein the metrics comprise a lateral error, a heading error, a lateral velocity, a yaw rate, a lateral acceleration, a steering angle, and a steering rate;
determining whether the metrics satisfy constraints for the metrics;
responsive to determining that the metrics do not satisfy the constraints for the metrics, performing a weight optimization; and
responsive to the metrics satisfying the constraints for the metrics, engaging a model predictive controller to control the vehicle.

18. The computer program product of claim 17, wherein the model predictive controller is disabled while the metrics do not satisfy the constraints for the metrics.

19. The computer program product of claim 18, wherein the weight optimization is performed iteratively until the metrics satisfy the constraints for the metrics.

20. The computer program product of claim 19, wherein the model predictive controller controls the vehicle by engaging an active safety feature, and wherein the active safety feature is selected from a group consisting of active cruise control, automated lane change, front collision alert, collision imminent breaking, and automated evasive steering.
